(19) United States
(12) Patent Application Publication
(10) Pub. No.: US 2016/0247225 A1
(43) Pub. Date: Aug. 25, 2016

(54) Option Box Volatility Indexes

(71) Applicant: Chicago Mercantile Exchange Inc., Chicago, IL (US)

(72) Inventors: John Kerpel, Chicago, IL (US); Lori Aldinger, Naperville, IL (US); Daniel Grombacher, Evanston, IL (US); John Labuszewski, Westmont, IL (US); Roberta Paffaro, Sao Paulo (BR)

(21) Appl. No.: 14/630,250

(22) Filed: Feb. 24, 2015

(51) Int. Cl. G06Q 40/04

(52) U.S. Cl. CPC G06Q 40/04

(57) ABSTRACT

An implied volatility index, according to at least some embodiments, may be calculated based on implied volatility values associated with a selected number of options whose strike prices surround the current price level in the underlying market. In some cases, the implied volatility index may be used as the value to which various derivative items may be cash-settled, including Exchange-traded securities, futures, and options on all asset classes for open outcry and electronic trading and submission for ex-pit clearing at a central counterparty (CCP) clearing house.

### BACKGROUND

In some cases, traders, or other investors, may desire to invest using a strategy based on a volatility seen in a financial marketplace. Currently, only limited options are available to these traders. For example, a trader may invest in options using a strategy involving a delta-hedged straddle or by investing in a traded volatility options product, such as a Chicago Board Options Exchange (CBOE) Market Volatility Index (VIX) futures product, a volatility index futures product (VSTOXX) offered via the Eurex Exchange, an implied volatility futures product (VDAX) offered via the Deutscher Aktien Index (DAX), and/or the like.

Options may be a popular investment vehicle due to a strictly limited associated risk, at least for an options buyer. In general, an options buyer may pay a cost of the option, known as the premium, upfront and in cash. Once paid, that premium represents the maximum possible loss to which the option buyer may be exposed. In many cases, options may be combined in different ways. For example, combinations of options may allow for different types of speculation and/or hedging. One such method is to buy (or sell) a call and a put, each having the same strike price and maturity. This combination may be referred to as a straddle. Straddles can be used to bet on large price movements of the product that underlies the option (e.g., the underlier). The bet may pay off when the underlier moves substantially in either direction. As such, a straddle may be considered to be a “play” on implied volatility.

However, the existing methods for determining an implied volatility index methods and corresponding systems are insufficient in various respects.

### SUMMARY

An implied volatility (IV) index according to at least some embodiments may be calculated based on implied volatility values associated with a limited number of options whose strike prices surround the current price level in the underlying market. In some cases, the implied volatility index may be used as the value to which various derivative items may be cash-settled, including Exchange-traded securities, futures, and options on all asset classes for open outcry and electronic trading and submission for ex-pit clearing at a central counterparty (CCP) clearing house.

In an illustrative embodiment, the systems and methods may include identifying, by a volatility index generator, an option-box type for use in generating an implied volatility index associated with an options product. The option-box type may correspond to a number of puts and calls near a strike price of the options product, where an implied volatility associated with each of the number of the puts and calls may be used in calculating the implied volatility index. The volatility index generator may also receive an implied volatility value corresponding to each of the number of puts and calls near the strike price defined by the option-box type. The implied volatility values may be calculated by an implied volatility calculator based on a pricing model. The volatility index generator may also calculate an index value based on the received implied volatility values corresponding to each of the number of puts and calls near the strike price. In some cases, the volatility index generator may calculate the index value as an average of the received implied volatility values. In other cases, the volatility index generator may calculate the index value as a weighted average of the received implied volatility index values.

The details of these and other embodiments of the present invention are set forth in the accompanying drawings and the description below. Other features and advantages of the invention will be apparent from the description and drawings.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows an illustrative trading network environment for implementing trading systems and methods according to at least some embodiments;

FIG. 2 shows a portion of an illustrative system for calculation and use of an option-box implied volatility index according to at least some embodiments;

FIG. 3 shows an illustrative flow diagram of a method for generating an implied volatility index according to at least some embodiments; and

FIG. 4 shows an illustrative chart including market information associated with an illustrative options product that may be used as a basis for an option-box index according to at least some embodiments.

### DETAILED DESCRIPTION

Many “volatility products” have been made available in the past or are currently available. These include products that reference the historic or realized volatility quoted as a standard deviation associated with a particular product. They extend to products that reference the historic or realized variance (e.g., a standard deviation squared) associated with a particular product. Further, other products may reference an index of implied volatilities (IVs) such as, most notably, the so-called VIX. The VIX represents an amalgam of the IVs associated with many options and generally extending to almost all options traded in a particular market in the nearby and deferred month. The IVs are weighted by reference to market activity (e.g., volume) and further weighted between the nearby and deferred contract months to create a stable 30-day reference.

This first class of volatility measures discussed above may be representative of historic observations and may not reference implied volatilities at all. A problem with these measures is that they are “backwards looking”. In other words, these measures may focus on the past and may not necessarily offer a projection into the future as does an implied volatility. In some cases, one may also observe that options, in some markets, may trade at IVs that are consistently above historic volatilities (HVs) as some traders bid up the value of options noting that their risk is limited to the option premium paid upfront, which may be considered to be an attractive feature.

The second class of volatility measures, such as the VIX, may suffer from complexity. For example, such volatility measures may reference a large number options in an attempt to be comprehensive and may also utilize complex weightings. As a result, volatility measures, such as the VIX, may be difficult to replicate. As such, these volatility measures may be difficult to hedge. Further, such methodology may become difficult to apply in less-liquid option markets, because a limited number of options may be actively traded. Sometimes, the trading activity may be limited to the nearby month alone.

As such, a need has been recognized for a methodology for creating indexes of implied volatility that reference the IVs associated with a limited number of options whose strike prices surround the current price level in the underlying market. Because the observed option strike prices surround or “box” the underlying market price, the systems and/or methods described herein may be referred to as an “option box volatility index”. In some cases, these systems and methods may be used as the value to which various derivative items may be cash-settled including, but not limited to, exchange-traded securities, futures, options on all asset classes for open outcry and electronic trading, and submission for ex-pit clearing at a central counterparty (CCP) clearing house.

Volatility

Market volatility may often be thought of as price movement in either direction (e.g., up or down). In this sense, the magnitude may be seen as more important than the direction of the movement. In some cases, a standard deviation of the pricing movements may be used as a measure of market volatility. In many cases, standard deviations may be expressed on an annualized basis. For example, a volatility may be quoted as a percentage (e.g., about 10%, about 15%, about 20%, etc.). By using the standard deviation metric, the underlying futures price movements may be modeled to imply a “normal price distribution.” In some cases, some option pricing models (e.g., Black Scholes options pricing model, Black options pricing model, etc.) may be based on an assumption that movements in an instrument underlying an option may be described in reference to the normal pricing distribution. This so-called “normal distribution” may be represented as a “bell-shaped curve”.

In an illustrative example, a volatility of 6% may be interpreted, with an approximate 68% degree of confidence that the price of the underlying instrument will be within plus or minus 6% (e.g., 1 standard deviation) of where the current price at the conclusion of one year. In another illustrative example, the price of the underlying instrument may be predicted, with a 95% degree of confidence, to be within plus or minus 12% of the current price at the conclusion of a year (e.g., 2 standard deviations). In many cases, a greater price volatility may correspond to a greater value of the option.

Historic volatility (e.g., realized volatility), may be calculated using the standard deviation of day-to-day returns in the market of interest. In some cases, these returns may be sampled over a specified time period (e.g., the past 30 days, 60 days, 90 days, 180 days, or some other period of interest) and the resulting number may be expressed on an annualized basis. An implicit assumption associated with historic volatility is that movements over specified historical time period may be reflective of future market movements. In some cases, however, the aggregate expectations of market participants, with respect to future volatility, may be at odds with past volatility. Thus, traders may reference “implied volatilities” or, in other words, the volatility that is implicit in the level of an option premium as traded in the market.

In computing a fair value of an option premium, one or more mathematical pricing models may be used. These various pricing models may be used to calculate the fair value of the option premium as a function of the underlying futures price (U), strike price (S), term until expiration (t), volatility (v) and short-term interest rates (r).

Premium=f(U,S,t,v,r) [1]

The underlying market price, strike price, term and short-term rates may be readily observable in a marketplace. Further, the value of the option premium trading in the marketplace may also be readily observable. This leaves volatility as the least readily observable and most abstract of noted variables. However, one may solve the mathematical pricing model to find volatility or “implied volatility” as a function of the observed premium and the other variables.

v=f(Premium,U,S,t,r) [2]

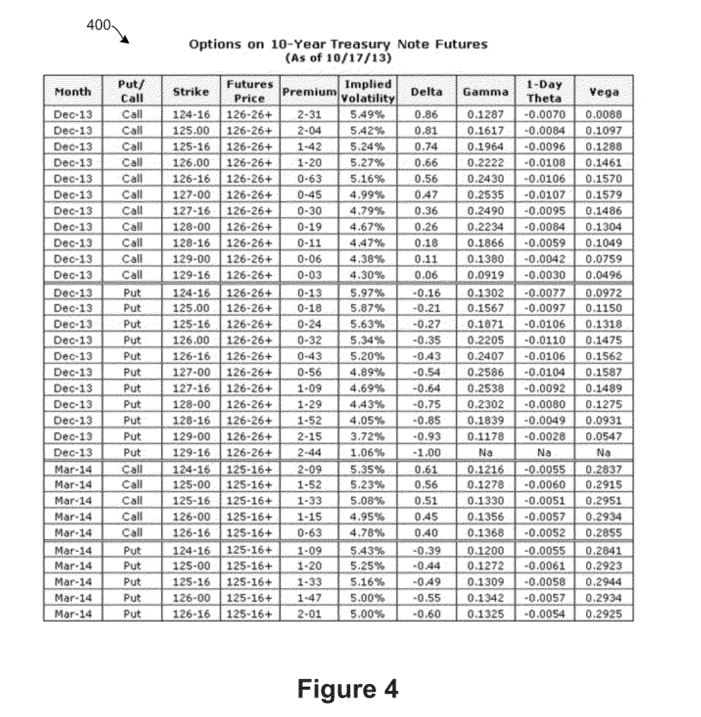

Referring to the table of FIG. 4, the implied volatilities associated with options sharing a common underlying instrument and sharing a same expiration date may be quite different. For example, an options product corresponding to a near-the-money 127 December 2013 put may have an implied volatility of 4.89%, while an out-of-the-money 126 put may have an implied volatility of 5.34%. Traders may impute different values to options based on subtly different investment attributes associated with the different options. Options on Treasury futures may be heavily utilized by institutional traders who often deploy these options for risk management purposes. As such, the institutional traders may tend to value less expensive out-of-the-money puts as a means of buying price protection. Thus, in some cases, the traders may bid up the value of less expensive out-of-the-money puts, particularly where they perceive a high risk of rising rates and falling Treasury prices.

This may create a pattern known as the option skew or “smile” by reference to the fact that a graphical display of this information sometimes resembles a smile. To put the data shown in FIG. 4 in perspective, Treasury rates had been generally drifting higher as of October 2013 based on anticipation that the Treasury might begin to “taper” its quantitative easing programs, leading to higher rates and lower prices. This anticipation was reflected in the skew such that low-struck puts were generally bid up, resulting in higher implied volatilities. Calls with the same strike likewise displayed progressively higher IVs as a result of a so-called “put-call parity” phenomenon.

For example, put-call parity may suggest that if puts and calls of the same strike price did not trade with approximately equal IVs, an arbitrage opportunity may arise. In some cases, execution of such an arbitrage may cause these IVs to align in equilibrium. For example, if a call were to trade significantly “richer” than a put with identical strikes, as measured by their respective IVs, a trader may desire to pursue a “conversion” strategy. This conversion strategy may entail the sale of the call and purchase of the put, creating a “synthetic short futures” position. This may be hedged by the simultaneous purchase of futures, effectively locking in an arbitrage profit. A “reverse conversion” or “reversal may be pursued if the put were trading richer than the call with the same strike. This reverse conversion may entail a sale of the put and purchase of the call, creating a “synthetic long futures” position. In some cases, a trader may hedge with the simultaneous sale of futures, locking in an arbitrage profit. Trader may continue to execute these traders until a market equilibrium has been restored, such as by the above mentioned trades, and it becomes unprofitable to continue placing these strategies, after considering the attendant transaction costs.

Exemplary Operating Environment

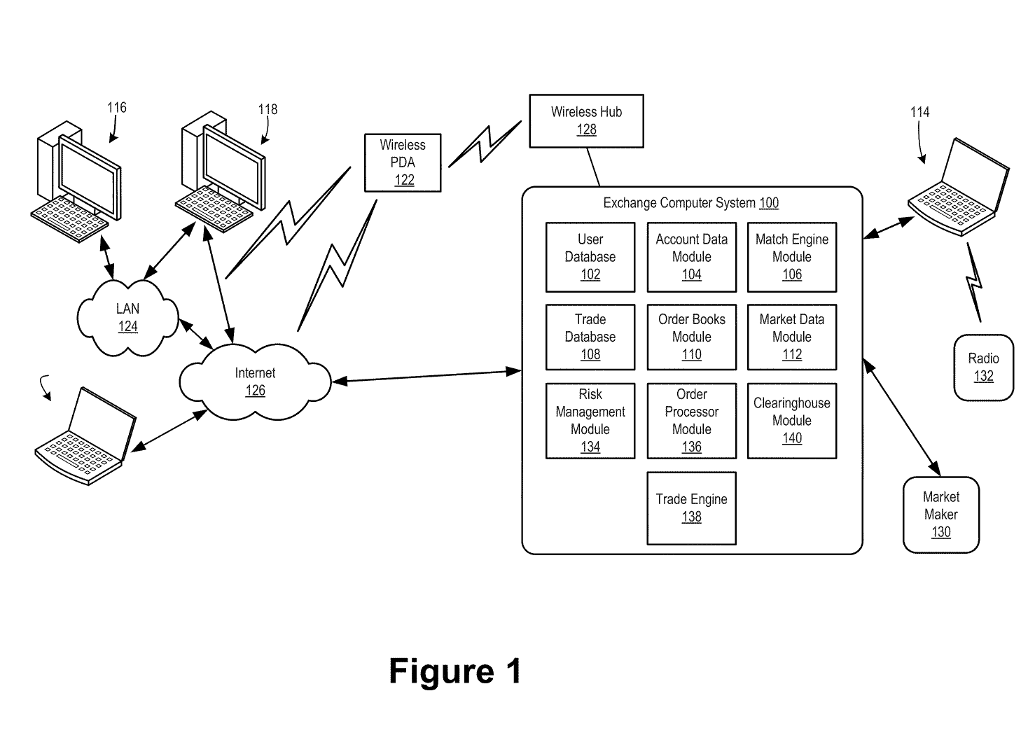

Aspects of at least some embodiments can be implemented with computer systems and computer networks that allow users to communicate trading information. An exemplary trading network environment for implementing trading systems and methods according to at least some embodiments is shown in FIG. 1. The implemented trading systems and methods can include systems and methods, such as are described herein, that facilitate trading and other activities associated with financial products based on currency pairs.

Computer system 100 can be operated by a financial product exchange and configured to perform operations of the exchange for, e.g., trading and otherwise processing various financial products. Financial products of the exchange may include, without limitation, futures contracts, options on futures contracts (“futures contract options”), and other types of derivative contracts. Financial products traded or otherwise processed by the exchange may also include over-the-counter (OTC) products such as OTC forwards, OTC options, etc.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses one or more 64-bit processors. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out clearinghouse operations. Module 140 may receive data from and/or transmit data to trade database 108 and/or other modules of computer system 100 regarding trades of futures contracts, futures contracts options, OTC options and contracts, and other financial products. Clearinghouse module 140 may facilitate the financial product exchange acting as one of the parties to every traded contract or other product. For example, computer system 100 may match an offer by party A to sell a financial product with a bid by party B to purchase a like financial product. Module 140 may then create a financial product between party A and the exchange and an offsetting second financial product between the exchange and party B. As another example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc. As discussed in further detail below, module 140 may determine values for performance bonds associated with trading in products based on various types of currency pairs.

Each of modules 102 through 140 could be separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-140).

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may implement one or more of the well-known LAN topologies and may use a variety of different protocols, such as Ethernet. Computer devices 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computer devices 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems (e.g., computer systems of clearing member firms), regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, clearinghouse module 140 and/or other modules of exchange computer system 100 may include computer-executable instructions for performing operations associated with determining performance bond contributions associated with holdings in products that are based on various types of currency pairs.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In some cases, the exchange computing system 100 may be configured to create and/or price an implied volatility derivative product based on an implied volatility of an underlying financial product. In at least some embodiments, the exchange computer system 100 (or “system 100”) receives, stores, generates and/or otherwise and processes data. In accordance with various aspects of the invention, the exchange computing system 100 may obtain pricing information corresponding to the underlying financial product from a financial market. This may promise a more straight-forward way for investors to take a position based on implied volatility of a financial product.

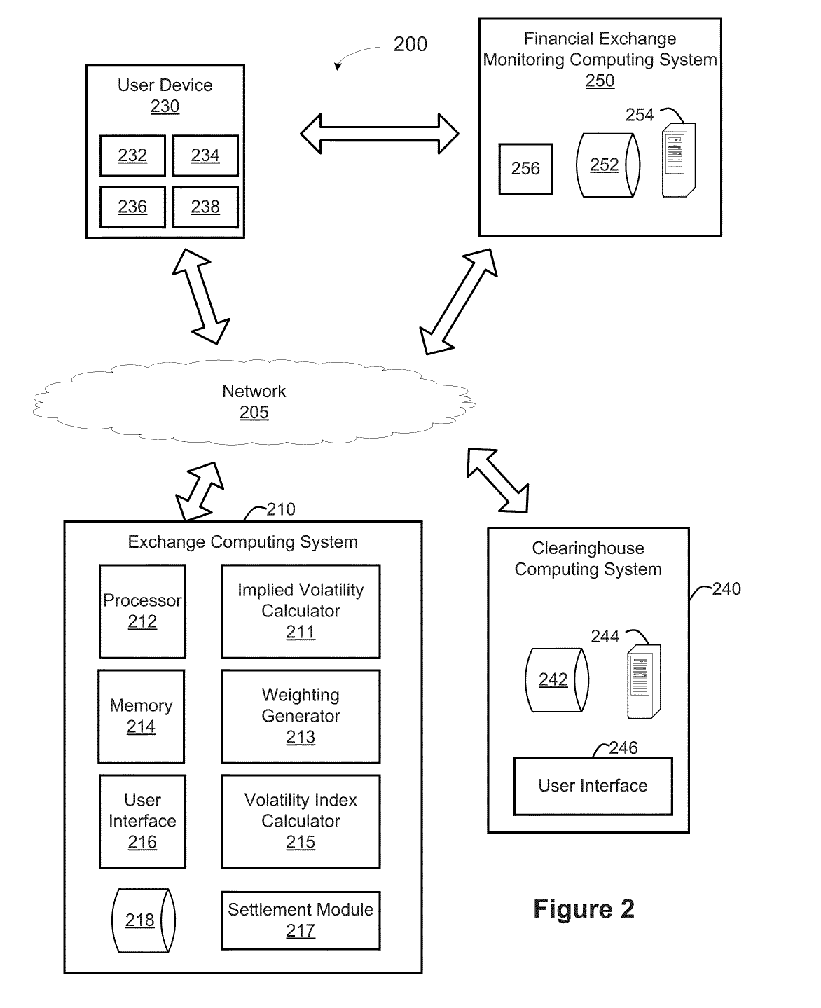

FIG. 2 shows a portion of an illustrative system 200 for calculation and use of an option-box implied volatility index according to some embodiments. In some cases, the illustrative system 200 may include an exchange computing system 210, such as the exchange computing system 100 of FIG. 1. The illustrative computing system 200 may further include one or more user devices 230, a clearinghouse computing system 240 and/or a financial exchange monitoring computing system 250. Each of the exchange computing system 210, the user devices 230, the clearinghouse computing system 240, and/or the financial exchange monitoring computing system 250 may be communicatively coupled via a network 205 (e.g., a wide area network (WAN), the LAN 124, the Internet 126, etc.). The exchange computing system 210 may include a data repository 212, one or more non-transitory memory device 214 (e.g., RAM, ROM, a disk drive, a flash drive, a redundant array of independent disks (RAID) server, and/or other such device etc.), a user interface device 216, and one or more processors, such as a processor 218. In some cases, the exchange computing system 210 may be configured to provide an implied volatility index associated with an options product offered via a financial exchange. The implied volatility index may be generated and/or processed by the exchange computing system 210 using information received from at least one of the financial exchange monitoring system and the one or more user devices 230 and/or the clearinghouse computer system.

The exchange computing system 210 may be configured to store instructions in the one or more memory devices 214 and/or the data repository 212 that, when executed by the processor 218, may configure the exchange computer system 210 to include one or more of implied volatility calculator 211, a weighting generator 213, a volatility index calculator 215 and a settlement module 217. Each of implied volatility calculator 211, the weighting generator 213, the volatility index calculator 215 and the settlement module may be communicatively coupled within the exchange computing system 210 and/or may be communicatively coupled to the user device 230, the clearinghouse computer system 240, and/or the financial exchange monitoring computing system 250 via the network 205. In some cases, the data repository 212 may be any combination of general purpose and/or special purpose data storage devices and/or software. For example, the data repository 212 may include database software (e.g., a database management system) running on a dedicated server and/or on one or more shared devices. The data repository may include a database server (e.g., a dedicated computer system) configured to run a database management system for storing information corresponding to financial markets and/or financial accounts. In some cases, the data repository may further store instructions to configure the processor 218 to provide the functionality of the implied volatility calculator 211, the weighting generator 213, the volatility index calculator 215, and/or the settlement module 217.

The user interface 216 may include one or more user display devices (e.g., a CRT display, an LCD display, and LED display, a touchscreen device) and/or data entry devices (e.g., a keyboard, a mouse, a touchscreen, etc.). For example, the user interface 216 may include a keyboard and mouse to facilitate user interaction with information provide via a display device, such as a monitor. In some cases, the user interface 216 may be configured to provide and/or solicit information to/from users, such as by using one or more user interface screens. The user interface 216 may process instructions and/or access information (e.g., images, instructions, text, etc.) stored in the memory 214 and/or the data repository 212 to generate the one or more user interface screens. In some cases, the user interface 216 may be provided locally to the exchange computer system 210, such as within a facility associated with a financial exchange. In other cases, the user interface 216 may be remote to a financial exchange facility. For example, the user interface 216 may be provided via the network 205 such via a remote device. In such cases, the exchange computing system 210 may be configured to provide user interface screens to the remotely located user interface 216. For example, the exchange computing systems may provide one or user interface screens to a remote device (e.g., the user device 230, the clearinghouse computing system 240, etc.) via the network 205. In such cases, the network 205 may be an open network (e.g., the Internet) or a closed network associated with the financial exchange and open to members of the financial exchange.

The processor 218 may include one or more microcontroller and/or microprocessors capable of processing instructions to provide one or more of the implied volatility calculator 211, the weighting generator 213, the volatility index calculator 215 the settlement module 217 and/or one or more user interface screens accessible via the user interface 216. The processor 218 may include a single core processor and/or a multi-core processor. In some cases, the processor 218 may include a distributed and interconnected set of processors, such as when the exchange computing system 210 is configured using a distributed computing model.

The processor 218 may be configured to process instructions and/or data stored in the memory 214 and/or the data repository 212 to provide an implied volatility index corresponding to an options product traded on a financial exchange. For example, the processor 218 may process instructions to provide an implied volatility index based on implied volatilities associated with puts and calls near a strike price of the options product. The processor 218 may calculate the implied volatility index as an average, or weighted average, of the implied volatilities associated with the puts and calls near the strike price of the options product. In some cases, the puts and calls near the strike price of the options product may be selected based on a defined option-box type. The option box types may correspond to the in-the-money and out-of-the-money puts and calls nearest to the strike price. For example, the processor 218 may process instructions to calculate the implied volatility index based on a 4 option box type, where the implied volatility index is calculated as an average, or weighted average) of the nearest in-the-money puts and calls and the nearest out-of-the-money puts and calls. In some cases, the processor 218 may use the implied index value when calculating a settlement price of the corresponding options product.

In some embodiments, an option-box based volatility index may be calculated by the volatility index calculator 215 using an un-weighted average of a “box” (e.g., cluster) of near-the-money options. In other cases, the option box volatility index may be calculated using a weighted average of the box (e.g., cluster) of near-the-money options by the volatility index calculator 215. In a first illustrative example, an option box volatility index may comprise a four (4) option box volatility index by taking an average (e.g., a weighted average, an un-weighted average, etc.) of the implied volatilities associated with the in-the-money puts and calls nearest to the strike price and the implied volatilities associated with the out-of-the-money puts and calls nearest to the strike price. In a second illustrative example, a six (6) option box volatility index may be constructed by using an average (e.g., the weighted average, the un-weighted average, etc.) of the implied volatilities associated with the closest to-the-money put, the closest to the money call, as well as the next higher struck puts and calls and the next lower struck puts and calls. In a third illustrative example, an eight (8) option box volatility index by taking the average (e.g., the weighted average, the un-weighted average, etc.) of the implied volatilities associated with the two nearest in-the-money puts, the two nearest in-the-money calls, the two nearest out-of-the-money puts, and the two nearest out-of-the-money calls. While the 4 option box volatility index, the 6 option box volatility index, and the 8 option box volatility index are discussed herein, those skilled in the art will appreciate that these examples are not meant to be limiting, but rather to provide illustrative examples of many possible implementations.

In some cases, the exchange computing system 210 may be configured to receive market information corresponding to the specified options product that may be used as a basis for the implied volatility index, such as from the financial exchange monitoring computing system 250. In some cases, the financial exchange monitoring computing system 250 may be associated with a financial institution (e.g., a bank, a brokerage firm, etc.) and used to monitor activity (e.g., trading activity) of one or more financial products traded on a financial exchange. The financial exchange monitoring computing system 250 may include one or more computing devices 254, a data repository 252 and a user interface 256. The user interface 256 may be accessible to a user local to the financial exchange monitoring computing system 250, or may be capable of providing remote access via the network 205 to a user. For example, a user may access financial information via one or more user interface screens displayed on the local user interface 256 and/or the user interface 236 of the remote user device 230. The data repository 252 may include trading information associated with one or more traded financial products (e.g., options products), such as pricing information (e.g., put information, call information, strike price information, market price information, etc.), volume information, premium information, term information, rate information and/or the like. In some cases, the financial exchange monitoring computing system 250 may include an implied volatility calculator configured to calculate an implied volatility associated with the options product using the trading information. The financial exchange monitoring computing system 250 may be configured to automatically communicate the trading information to the financial exchange computing system 210. In other cases, the financial exchange monitoring computing system 250 may be configured to communicate the trading information in response to a request for the market information

In some cases, the implied volatility calculator 211 may be configured to calculate an implied volatility associated with a strike, a put and/or a call based on the market information provided by the financial exchange monitoring computing system 250. For example, the implied volatility may be calculated as a function of one or more variables observable in the financial market. In some cases, implied volatilities associated with option contracts having a range of strike prices and/or time to maturity may be determined using specified option volatility model. In various embodiments of the invention volatility may be calculated via one or more different models, such as a Black-Scholes model, a Black model, a Binomial model, and/or the like. In an illustrative example, implied volatilities associated with options contracts may be determined using a Black Scholes model based upon one or more calls/puts. Calculating implied volatility for pricing puts and calls using the Black Scholes model may be done as follows:

P(S,T)=Ke^{-rT}Φ(−d₂)−SΦ(−d₁) [3]

C(S,T)=SΦ(d₁)−Ke^{-rT}Φ(d₂) [4]

were,

$$\begin{matrix}{d}_{1} = \frac{ln ( \frac{S}{K} ) + ( r + \frac{{σ}^{2}}{2} ) T}{σ \sqrt{T}} \\ and & [ 5 ] \\ {d}_{2} = \frac{ln ( \frac{S}{K} ) + ( r - \frac{{σ}^{2}}{2} ) T}{σ \sqrt{T}} = d 1 - σ \sqrt{T} & [ 6 ]\end{matrix}$$

where:
φ is the standard normal distribution function,
P=put price,
C=call price,
S=underlying asset price,
K=strike price,
r=risk free rate,
σ=implied volatility, and
T=remaining time to maturity/expiration.

If P and/or C are known, since the market determined the price either intra-day or at close of business, S, K, r and T may also be known. Those values can be plugged in and a search performed to find the closest σ (e.g., implied volatility) that produces the realized P or C. The search algorithm can be any of many widely used algorithms such as the bisection method or Newton-Raphson method.

Note that the referenced options may be amended on an ongoing (e.g., periodic) basis, such as on a daily, weekly, or monthly basis. During this ongoing time, as the underlying market price fluctuates upwards or downwards, the subject options may fall in-the-money or out-of-the-money. Further, in some cases, options may be “rolled over” from the nearby contract month to the first deferred contract month at a pre-specified point in time, such as when an expiration of the nearby contracts approaches.

In some cases, the weighting generator 213 may be configured to associate the weights with each option's implied volatility may be assigned by reference to one or more factors, such as volume over a specified recent historic period or “rolling” period, open interest over a specified recent historic period or “rolling” period, and/or, other such factors. In some cases, the weighting generator 213 may disable the weightings by setting each weighting to 1.

In some cases, an option box volatility index may be calculated by the volatility index calculator 215 using an un-weighted average of a “box” (e.g., cluster) of near-the-money options. In other cases, an option box volatility index may be calculated using a weighted average of the box (e.g., cluster) of near-the-money options. or, in another iteration of the invention, a weighted average of a “box” or cluster of near-the-money options. In a first illustrative example, an option box volatility index may comprise a four (4) option box volatility index by taking an average (e.g., a weighted average, an un-weighted average, etc.) of the implied volatilities associated with the in-the-money puts and calls nearest to the strike price and the implied volatilities associated with the out-of-the-money puts and calls nearest to the strike price. In a second illustrative example, a six (6) option box volatility index may be constructed by using an average (e.g., the weighted average, the un-weighted average, etc.) of the implied volatilities associated with the closest to-the-money put, the closest to the money call, as well as the next higher struck puts and calls and the next lower struck puts and calls. In a third illustrative example, an eight (8) option box volatility index by taking the average (e.g., the weighted average, the un-weighted average, etc.) of the implied volatilities associated with the two nearest in-the-money puts, the two nearest in-the-money calls, the two nearest out-of-the-money puts, and the two nearest out-of-the-money calls. While the 4 option box volatility index, the 6 option box volatility index, and the 8 option box volatility index are discussed herein, those skilled in the art will appreciate that these examples are not meant to be limiting, but rather to provide illustrative examples of many possible implementations.

Note that the referenced options may be amended on an ongoing (e.g., periodic) basis, such as on a daily, weekly, or monthly basis. During this ongoing time, as the underlying market price fluctuates upwards or downwards, the subject options may fall in-the-money or out-of-the-money. Further, in some cases, options may be “rolled over” from the nearby contract month to the first deferred contract month at a pre-specified point in time, such as when an expiration of the nearby contracts approaches.

We may generalize this concept, consider the following formula.

$$Index = [ {\sum }_{i = 1}^{n} {W}_{i} {IV}_{i} ] \div n$$

where
n=number of options referenced in the index;
Wᵢ represents the weight assigned to each option's implied volatility; and
IVᵢ represents the implied volatility associated with each option.

In an illustrative example using the information of chart 400 of FIG. 4, an un-weighted 6-option box volatility index may reference the Dec-13 calls and puts struck at 126-16, 127-00 and 127-00. To the extent that this is an un-weighted calculation, the weights (e.g., Wᵢ) associated with each implied volatility equal 1 and implicitly drop from the calculation. As such, the value of the index may be computed as:

Index=[5.16%+4.99%+4.79%+5.20%+4.89%+4.69%]÷6=4.95333%

These indexes may be applied in any number of applications. For example, an option box volatility index may be used, such as by the settlement module 217, when computing the final settlement value for the cash settlement of derivative contracts including, for example, exchange-traded securities, futures or options on all asset classes for open outcry and electronic trading, and/or when submitting for ex-pit clearing at a central counterparty (CCP) clearing house such as by the clearinghouse computing system 240.

The one or more user devices 230 may include a workstation, a personal computer (e.g., the computer 120), a tablet computer, a smart phone, or the like. The user device 230 may include a data repository 232, a memory 234, a user interface 236, and a processor 238. In some cases, an individual, such as an employee of the financial exchange, may specify an option box type (e.g., a 4 option box type, a 6 option box type, an 8 option box type, etc.) via a user interface and/or a user interface screen. In some cases, the user may also identify an option product for which an implied volatility index is desired to be created. The user may also, such as via a user interface, select one or more weightings to be applied to the implied volatilities associated with each of the puts and calls used in generating the implied volatility index. The user device 230 may include a communication interface to communicatively couple the user device 230 to one or more of the financial exchange monitoring computing system 250 and/or the exchange computing system 210. For example, the user may view, via a user interface screen, market information associated with one or more options products. The user device 230 may be configured to process instructions stored in the memory 234 and/or the data repository 232 to present one or more user interface screens via the user interface 236.

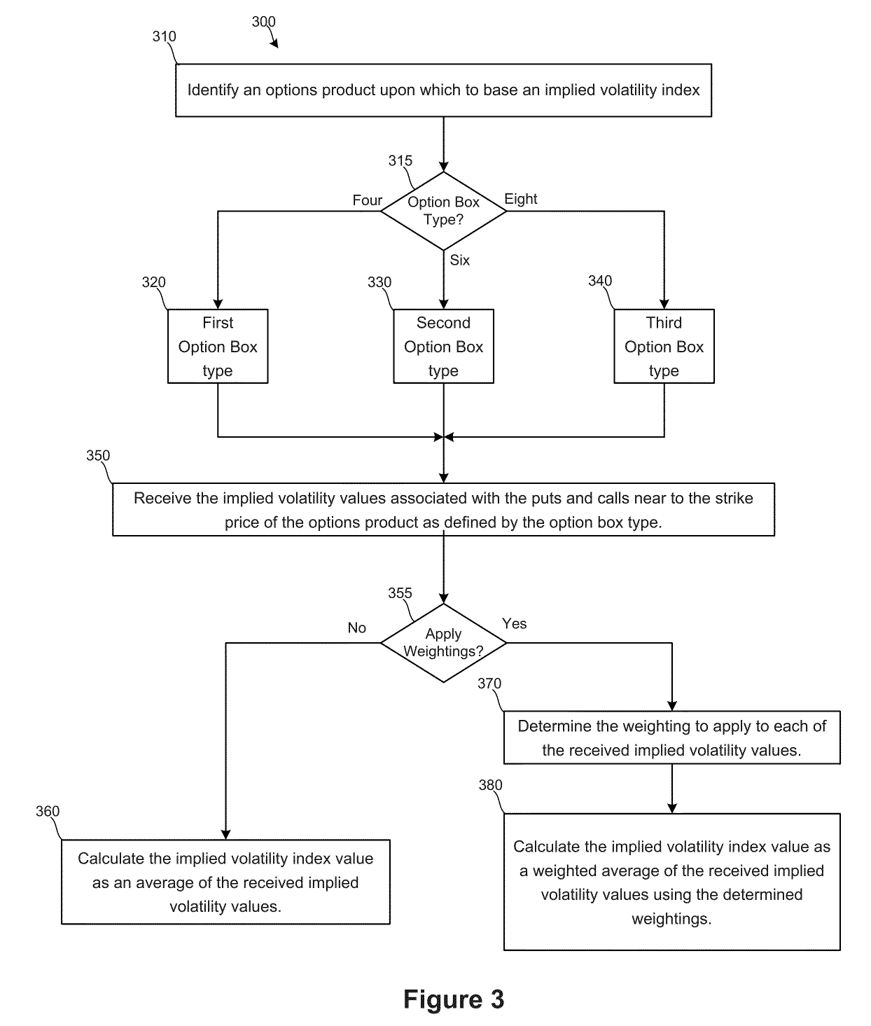

FIG. 3 shows an illustrative flow diagram 300 of a method for generating an implied volatility index in accordance with an aspect of the invention. In some cases, at 310, the exchange computing system 210 may be configured to identify an options product upon which to base an implied volatility index. In some cases, the options product may be selected via an algorithm running on the exchange computing system 210. In other cases, the options product may be selected by a user, such as via a user interface screen displayed by a display device associated with the user device 230.

At 315, an option-box type associated with the implied volatility index may be determined by the exchange computing system 210. In some cases, the user may define the option box type (e.g., a 4 option box type, a 6 option box type, an 8 option box type, etc.) via the user device 230. In other cases, the exchange computing system may determine which option box type to use in creating the implied volatility index. For example, one or more option box types may be associated with a rule, or set of rules. For example, a default option box type may be used when a user declines, or otherwise does not define an option box type. In such cases, for example, the exchange computing system may be configured to generate the implied volatility index using a first option box type when no other option box type had been defined. In the illustrative example of FIG. 3 if, at 315, the user selects a four (4) option box type, the volatility index calculator 215 may be configured at 320 to calculate the volatility index using the implied volatilities associated with the in-the-money puts and calls nearest to the strike price and the implied volatilities associated with the out-of-the-money puts and calls nearest to the strike price. If, at 315, the user selects a six (6) option box type, the volatility index calculator 215 may be configured, at 330, to calculate the volatility index using the implied volatilities associated with the closest to-the-money put, the closest to the money call, as well as the next higher struck puts and calls and the next lower struck puts and calls. If, at 315, the user selects an eight (8) option box type, the volatility index calculator 215 may be configured, at 330, to calculate the volatility index using the implied volatilities associated with the two nearest in-the-money puts, the two nearest in-the-money calls, the two nearest out-of-the-money puts, and the two nearest out-of-the-money calls. At 350, the volatility index calculator 215 may then receive the implied volatility values associated with the puts and calls near to the strike price of the options product as defined by the option box type.

At 355, the volatility index calculator 215 may be configured to determine whether or not to apply weightings to the implied volatilities when determining the index value. If, at 355, no weightings are to be applied, then the implied volatility index may be calculated as an average of the implied volatilities associated with the puts and calls near the strike price as defined by the option box type. If, at 355, weightings are to be applied, the volatility index calculator 215 may receive weightings from the weighting generator 213. The weightings generator 213 may be configured to determine a weighting to be applied to each of the implied volatilities associated with the puts and calls near the strike price. For example, the weightings may be assigned based on a “nearness” to the strike price. For example, puts and calls nearer to the strike price may be weighted more heavily than the puts and calls farther away from the strike price. In other cases, the puts may be weighted more heavily than the calls, or the calls may be weighted more heavily than the puts. In some cases, each put and call may be weighted equally. Once the weightings have been defined, the volatility index calculator 215 may calculate the implied volatility index values based on the implied volatility values associated with the puts and calls as defined by the options type and the weightings as provided by the weightings generator 213. For example, the volatility index calculator 215 may calculate the volatility index as a weighted average of the volatilities associated with the puts and calls defined by the option box type.

The present invention has been described in terms of preferred and exemplary embodiments thereof. Numerous other embodiments, modifications and variations within the scope and spirit of the invention will occur to persons of ordinary skill in the art from a review of this disclosure. For example, aspects of the invention may be used to process and communicate data other than market data.

What is claimed is:

1. A system comprising:
a processor; and
a non-transitory memory device communicatively coupled to the processor, the non-transitory memory device storing instructions that, when executed by the processor, cause the processor to:
identify, by a volatility index generator, an option-box type for use in generating an implied volatility index associated with an options product, the option-box type corresponding to a number of puts and calls near a strike price of the options product;
receive, by the volatility index generator, an implied volatility value corresponding to each of the number of puts and calls near the strike price defined by the option-box type; and
calculate, by the volatility index generator, an index value based on the received implied volatility values corresponding to each of the number of puts and calls near the strike price.

2. The system of claim 1, wherein the non-transitory memory device stores further instructions that, when executed by the processor, cause the processor to:
calculate, by the volatility index generator, the index value as an average of the received implied volatility values corresponding to each of the number of puts and calls near the strike price.

3. The system of claim 1, wherein the non-transitory memory device stores further instructions that, when executed by the processor, cause the processor to:
calculate, by the volatility index generator, the index value as a weighted average of the received implied volatility values corresponding to each of the number of puts and calls near the strike price.

4. The system of claim 3, wherein the system further comprises an implied volatility calculator communicatively coupled to the volatility index generator, wherein the implied volatility calculator calculates the implied volatility for each of the number of puts and calls based on one or more pricing models.

5. The system of claim 4, wherein the implied volatility calculator calculates the implied volatility based on at least one of a Black-Scholes model and a Binomial model.

6. The system of claim 4, wherein the implied volatility calculator calculates the implied volatility based on a pricing model associated with European options.

7. The system of claim 4, wherein the implied volatility calculator calculates the implied volatility based on a pricing model associated with American options.

8. The system of claim 1, further comprising a user interface device providing at least one user interface screen for defining a financial product upon which the implied volatility index is based.

9. The system of claim 8, wherein the user interface device further provides a user interface screen for selecting the option-box type defining the number of puts and calls nearest to the strike price of the options product for use in calculating the index value.

10. The system of claim 1, wherein the option-box type corresponds to use of implied volatilities associated with a plurality of puts and calls nearest to the strike price, wherein the option-box type defines using in-the-money puts and calls nearest to the strike price and the implied volatilities associated with out-of-the-money puts and calls nearest to the strike price.

11. An apparatus comprising:
a processor; and
a non-transitory memory device communicatively coupled to the processor, the non-transitory memory device storing instructions that, when executed by the processor, cause the apparatus to:
identify, by a volatility index generator, an option-box type for use in generating an implied volatility index associated with an options product, the option-box type corresponding to a number of in-the-money puts and calls nearest to a strike price and out-of-the-money puts and calls nearest to the strike price of the options product;
receive, by the volatility index generator, an implied volatility value corresponding to each of the number of puts and calls near the strike price defined by the option-box type; and
calculate, by the volatility index generator, an index value based on the received implied volatility values corresponding to each of the number of puts and calls near the strike price.

12. The apparatus of claim 11, wherein the non-transitory memory device stores further instructions that, when executed by the processor, cause the apparatus to:
calculate, by the volatility index generator, the index value as an average of the received implied volatility values corresponding to each of the number of in-the-money puts and calls and out-of-the-money puts and calls nearest to the strike price.

13. The apparatus of claim 11, wherein the non-transitory memory device stores further instructions that, when executed by the processor, cause the apparatus to:
calculate, by the volatility index generator, the index value as a weighted average of the received implied volatility values corresponding to each of the number of puts and calls near the strike price.

14. The apparatus of claim 11, wherein the non-transitory memory device stores further instructions that, when executed by the processor, cause the apparatus to:
calculate, by an implied volatility calculator, the implied volatility for each of the number of puts and calls based on one or more pricing models.

15. The apparatus of claim 14, wherein the implied volatility calculator calculates the implied volatility based on at least one of a Black-Scholes model and a Binomial model.

16. The apparatus of claim 14, wherein the implied volatility calculator calculates the implied volatility based on a pricing model associated with European options or a pricing model associated with American options.

17. The apparatus of claim 11, wherein the non-transitory memory device stores further instructions that, when executed by the processor, cause the apparatus to:
receive, via a user interface screen, an identification of a financial product upon which the implied volatility index is based; and
receive, via the user interface screen, an identification of the option-box type for use in calculating the index value.

18. The apparatus of claim 11, wherein a first option-box type corresponds to use of the implied volatilities associated with in-the-money puts and calls nearest to the strike price and the implied volatilities associated with out-of-the-money puts and calls nearest to the strike price, a second option-box type corresponds to use of implied volatilities associated with a closest to-the-money put, a closest to the money call, as well as a next higher struck put and a next higher struck call, a next lower struck put and a next lower struck call; and a third option-box type corresponds to use of implied volatilities associated with two nearest in-the-money puts, two nearest in-the-money calls, two nearest out-of-the-money puts, and two nearest out-of-the-money calls.

19. A method comprising:
receiving, via a user interface, an identification of an options product corresponding to an implied volatility index;
determining, by a volatility index generator, an identification of an option-box type identifying a number of puts and calls near a strike price of the options product upon which the implied volatility index is based; and
calculating, by a volatility index generator, an implied volatility index value based on implied volatility values corresponding to each of the number of puts and calls near the strike price as defined by the option-box type, wherein the implied volatility index value is calculated as a weighted average of the implied volatility values.

20. The method of claim 19, further comprising:
assigning, by a weighting generator, a weighting to the implied volatility values corresponding to each of the number of puts and calls near the strike price.
